(19) United States
(12) Patent Application Publication
(10) Pub. No.: US 2019/0122786 A1
(43) Pub. Date: Apr. 25, 2019

(54) Cable And Method For Production Of A Cable

(71) Applicant: Kromberg & Schubert GmbH & Co. KG, Renningen (DE)

(72) Inventors: Marko Menge, Reken (DE); Dietmar Herzog, Ratingen (DE); Wolfgang Kindervater, Hamminkeln (DE)

(21) Appl. No.: 16/225,477

(22) Filed: Dec. 19, 2018

Related U.S. Application Data
(63) Continuation of application No. PCT/EP2017/064348, filed on Jun. 13, 2017.

(30) Foreign Application Priority Data
Jun. 24, 2016 (DE) 10 2016 111 612.2

(51) Int. Cl. H01B 7/02; H01B 3/46; H01B 13/14

(52) U.S. Cl. CPC H01B 7/0275; H01B 7/1885; H01B 13/141; H01B 3/46

(57) ABSTRACT

A cable has an electrically conductive core (4) made of one or more individual conductors and having an insulation surrounding the core (4). The insulation is made from a silicone material. The insulation has at least two separate silicone layers (1, 2). The two layers are formed from different silicone material. The first silicone layer (1) surrounds the core (4). The first silicone layer (1) is designed as an insulation inner layer made from a non-pressurized peroxide-crosslinked silicone material. The second silicone layer is applied to the insulation inner layer. It is an insulation outer layer and is formed from an addition-crosslinked silicone material.

### CROSS-REFERENCE TO RELATED APPLICATIONS

This application is a continuation of International Application No. PCT/EP2017/064348, filed Jun. 13, 2017, which claims priority to German Application No. 10 2016 111 612.2, filed Jun. 24, 2016. The disclosures of the above applications are incorporating herein by reference.

### FIELD

The disclosure relates to a cable having an electrically conductive core made of one or more individual conductors with an insulation surrounding the core, and to a method of production of the cable.

### BACKGROUND

For cable insulation used in automobiles, it is known to use silicone materials. In particular, silicone materials are cost-effective non-pressurized peroxide-crosslinked materials that achieve, on the one hand, good insulation and, on the other hand, mechanical protection of the individual electrical conductors. However, these silicone materials have the disadvantage that the byproducts released during the crosslinking form a slightly sticky layer on the surface of the insulation. This disadvantageously leads to the individual cable layers sticking together during the winding of the cables on cable spools. In order to prevent this, a separating agent layer in powder form, for example, a talc powder, is necessary.

Due to the high pressure of the wound cable layers, these separation agent layers can no longer be removed at a later time without leaving a residue. This disadvantageously makes the subsequent processes more difficult, such as, for example, a waterproof overmolding or overcasting. Another disadvantage is that the above-mentioned byproducts of the non-pressurized peroxide crosslinking are not only deposited on the cable outer surface but instead can also be found on the conductor surfaces because of diffusion processes. These depositions have a negative effect on a welding process for connecting electrical conductors, in particular ultrasound welding.

### SUMMARY

An objection of the present disclosure is to provide an improved cable. A cable with improved haptic properties, with improved producibility that has resistance to the operating substances with which the cables come in contact during use or processing.

This object is achieved by a cable having the features of a cable comprising an electrically conductive core made of one or more individual conductors. An insulation surrounds the core. The insulation is made from a silicone material. The insulation further comprises at least two separate silicone layers that include different silicone material. The first silicone layer surrounding the core is designed as an insulation inner layer made from a non-pressurized peroxide-crosslinked silicone material. The second silicone layer is applied to the insulation inner layer as an insulation outer layer and is formed from an addition-crosslinked silicone material.

In a known manner, the cable according to the disclosure comprises an electrically conductive core made of one or more individual conductors or made of several strands with individual conductors. This electrically conductive core is surrounded by an insulation made of a silicone material. The insulation comprises at least two layers. Each layer is made of different silicone materials.

In a preferred embodiment, an insulation layer made of a non-pressurized peroxide-crosslinked silicone material is applied directly onto the core. This basic insulation here represents a thick layer that ensures the essential insulation properties, namely the electrical insulation, the filling in irregularities as well as the mechanical protection of the conductors. In contrast to the prior art, no application of a separation agent in powder form is provided for this insulation inner layer. Here, an insulation outer layer made of an addition-crosslinked silicone material is provided. This insulation outer layer represents a thin layer in comparison to the insulation inner layer. In an advantageous manner, this insulation outer layer is firmly connected to the insulation inner layer and has a non-sticky surface. Thus, a separation agent in powder form can be eliminated. Like a talcum layer, for example, this thin insulation outer layer prevents the deposition of byproducts of the crosslinking of the insulation inner layer on the cable surface. In an advantageous manner, it is moreover possible to overmold or overcast such a cable in subsequent processes, since no separating substances are present on the cable surface. Moreover, the cable layers do not stick together during the winding of the cable on cable spools.

Cables with insulations made of a silicone material cannot be used in all vehicle sectors due to the operating substances used there, such as, for example, mineral oils or battery acid. For this reason, additional protective measures have been provided in the past, such as cable ducts or corrugated pipes. In an embodiment of the present cable, in order to increase the resistance to operating substances, the insulation outer layer is made of an addition-crosslinked silicone material containing fluorine, i.e., a fluorosilicone material. This increases the resistance of the cable insulation. By means of such an insulation outer layer made of fluorosilicone material, the above-mentioned protective measures can be eliminated.

Also, for example, the present cables advantageously have a higher mechanical resistance, since addition-crosslinked silicone materials have higher tear resistance. This is important in cable production. During insulation removal from or stripping of cables, the insulation is cut into only on the surface, so as not to damage the underlying individual electrical conductors. Therefore, it is desirable that the silicone material which has not been cut into tears off easily and without sharp edges. For this reason, the tear resistance of the insulation material should not be excessively high, which, however, reduces the mechanical resistance. The thick insulation inner layer has a relatively low tear resistance. The insulation outer layer consisting of addition-crosslinked silicone material has a higher tear resistance and a higher mechanical resistance. Due to the application of this insulation outer layer in the form of a thin cover layer, the mechanical resistance of the cable is improved while the good producibility is nevertheless maintained.

In order to be able to distinguish different cables, the insulations of the cables are dyed. For the present cables, high-temperature pigments can be used. Preferably, the pigments are introduced only into the insulation outer layer. The underlying insulation layer remains undyed. Thus, it is possible to achieve a savings on expensive color pigments. In addition, the dying processes can be shortened during color changes on extrusion installations.

In another embodiment, in addition to the insulation inner layer and the insulation outer layer, a separation layer is provided. This separation layer is arranged between the core and the insulation inner layer. The separation layer includes an addition-crosslinked silicone material. Such a separation layer is provided in particular in the case of cables that are used as energy-carrying cables in the automobile sector and that have to be connected with contact parts. This occurs as a rule by welding processes, for example, by ultrasound welding. The welding process is very sensitive to friction-reducing substances on the surface of the individual electrical conductor to be welded. The separation layer prevents byproducts of the non-pressurized peroxide crosslinking of the insulation inner layer from diffusing onto the conductor surface to be welded. A direct contact of the peroxide-crosslinked insulation layer with the wires of the conductors of the electrically conductive core is thus prevented. Accordingly, no contamination of the conductor surface can occur. In comparison to separation layers made of plastic films or metal-plastic composite films, for example, such a separation layer has the advantage that this separation layer, made of the addition-crosslinked silicone material, forms a firm connection with the insulation inner layer. Thus, it presents no problems during the subsequent cable production steps. During stripping, it tears off cleanly with the insulation inner layer and the insulation outer layer.

For the production of the present cable, the electrically conductive core is provided with the two insulation layers directly or after the application of a separation layer. On the core, a first layer for the insulation inner layer made of a mixture for a silicone material is applied. The mixture that can undergo non-pressurized peroxide crosslinking. A typical formula for such a peroxide-crosslinkable silicone material contains, for example:

HTV silicone Shore A 60 to 80

with

1.3 to 1.8% crosslinking agent bis-(2,4-dichlorobenzoyl) peroxide,

0.8 to 1.0% reversion stabilizer,

0.5 to 2.0% heat stabilizer.

Subsequently, on this first layer, an additional layer made of a mixture is applied. The mixture contains an addition-crosslinkable silicone material. This can be, for example, a mixture having the composition:

HTV silicone addition-crosslinking, Shore A 60 to 80, components A and B

with

0.5 to 3.0% heat stabilizer

0.5 to 1.0% HTV color paste.

Both layers are subsequently crosslinked in a heating device, preferably at temperatures of 160 to 200° C.

The application of the layers can occur successively in a two-layer extruder, or else the two layers can be applied successively by two different extruders to the core or to a core provided with a separation layer.

If a separation layer is provided, then this separation layer is applied to the core before the two mixtures for the insulation inner layer and for the insulation outer layer are applied. A separation layer made of an addition-crosslinkable silicone material can be crosslinked individually or together with the subsequent insulation layers in a heating device.

If, for the separation layer, an addition-crosslinking silicone material is used, the monomer content has been reduced beforehand by a special purification, which leads to the reduction of fogging, so that an activation of the crosslinking process can occur either as described above thermally and under non-pressurized conditions, or else by UV light.

Other advantageous developments of the disclosure are characterized in the dependent claims and represented in greater detail below together with the description of the preferred design of the disclosure in reference to the figures.

### DRAWINGS

Embodiment examples of the disclosure are described below in reference to the drawings. The disclosure is not limited to these embodiment examples. The drawings, in reference to figures, shows the basic design of the present, namely:

FIG. 1 is a cross section through a first embodiment of a cable.

FIG. 2 is a cross section through an additional embodiment of a cable with a separation layer.

### DETAILED DESCRIPTION

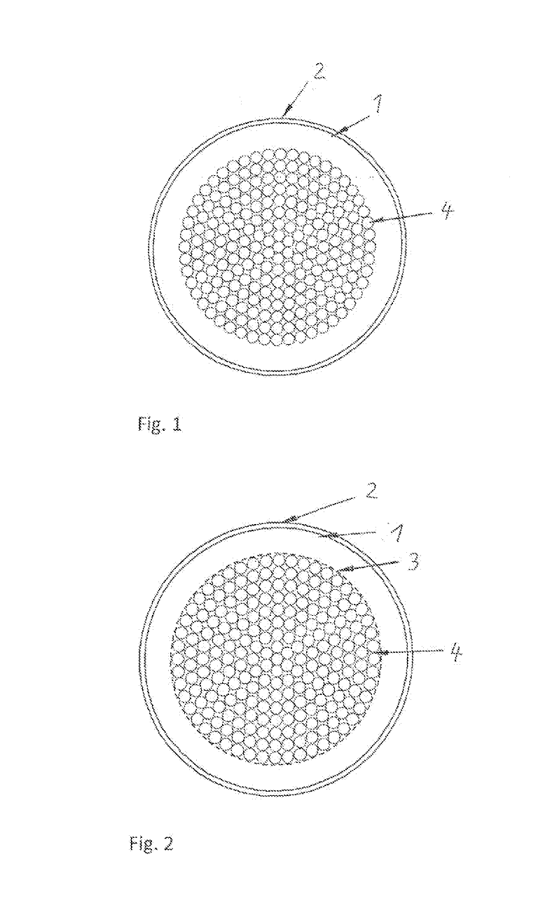

FIG. 1 shows a cross section through an cable including an electrically conductive core 4. In this case, the conductive core is made of multiple individual conductors. This core 4 is surrounded by insulation, namely by an insulation inner layer 1 and an insulation outer layer 2. The insulation inner layer 1 includes a non-pressurized peroxide-crosslinked silicone material and ensures basic insulation. This basic insulation here represents a thick layer that ensures the essential insulation properties. They are the electrical insulation, the filling in of irregularities as well as the mechanical protection of the wires of the core 4. The thickness of such an insulation inner layer 1 is preferably 0.2 to 1.5 mm.

The outer thin insulation layer 2 is used as a cover layer. It has a thickness of only 0.05 to 0.5 mm. It includes an addition-crosslinked silicone material. This thin insulation outer layer 2 prevents the deposition of byproducts of the crosslinking of the insulation inner layer 1 on the cable surface. Thus, a sticking together of the cable layers during the winding of the cable onto cable spools does not occur.

In FIG. 2, another embodiment of a cable is shown. In this cable, a separation layer 3 is additionally provided. The separation layer 3 is applied directly to the core 4 and separates the core 4 from the insulation inner layer 1. This separation layer 3 includes an addition-crosslinked silicone material and, like the insulation outer layer 2, it likewise has a small thickness of preferably 0.05 to 0.5 mm. In particular, as materials for the separation layer, such addition-crosslinked silicone materials are used, the monomer content of which has been reduced beforehand by special purification, so that they exhibit reduced fogging properties. The crosslinking of such a silicone material can occur either thermally under non-pressurized conditions or in less time by UV light.

The present disclosure has been described with reference to the preferred embodiment. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

1-8. (canceled)

9. A cable comprising an electrically conductive core made of one or more individual conductors;
an insulation surrounding the core, the insulation made from a silicone material, the insulation further comprises:
at least two separate silicone layers that include different silicone material, the first silicone layer surrounding the core is designed as an insulation inner layer made from a non-pressurized peroxide-crosslinked silicone material, and the second silicone layer is applied to the insulation inner layer as an insulation outer layer and is formed from an addition-crosslinked silicone material.

10. The cable according to claim 9, wherein the insulation inner layer, used as basic insulation, has a thickness of 0.2 to 1.8 mm, and the outer insulation outer layer, used as a cover layer, has a small thickness of 0.05 to 0.5 mm.

11. The cable according to claim 9, wherein the insulation outer layer includes an addition-crosslinked fluorosilicone material.

12. The cable according claim 9, further comprising a separation layer, the separation layer is arranged between the core and the insulation inner layer, the separation layer includes an addition-crosslinked silicone material and the separation layer has a thickness of 0.05 to 0.5 mm.

13. The cable according to claim 9, further comprising color pigments introduced only into the insulation outer layer.

14. A method for production of a cable, where the electrically conductive core is provided with an insulation made of crosslinkable silicone materials, on the core, comprising:
applying a first insulation inner layer made of a first mixture onto the core, the mixture includes a non-pressurized peroxide-crosslinkable silicone material;
applying an insulation outer layer made of a second mixture to the first insulation inner layer, the second mixtures includes an addition-crosslinkable silicone material; and
heating the two layers to crosslink the two layers together in a heating device.

15. The method according to claim 14, wherein the two different insulation layers are applied onto the core in a two-layer extruder.

16. The method according to claim 14, wherein prior to the application of the two insulation layers, applying a separation layer onto the core, the separation layer, is applied as a third mixture, the third mixture including an addition-crosslinkable silicone material, and the separation layer is crosslinked together with the two subsequently applied insulation layers.
